(19) United States
(12) Patent Application Publication
(10) Pub. No.: US 2015/0117753 A1
(43) Pub. Date: Apr. 30, 2015

(54) COMPUTING DEVICE AND METHOD FOR DEBUGGING COMPUTERIZED NUMERICAL CONTROL MACHINE

(71) Applicants: FU TAI HUA INDUSTRY (SHENZHEN) CO., LTD., SHENZHEN (CN); HON HAI PRECISION INDUSTRY CO., LTD., NEW TAIPEI (TW)

(72) Inventors: CHIH-KUANG CHANG, New Taipei (TW); XIN-YUAN WU, Shenzhen (CN); LU YANG, Shenzhen (CN)

(21) Appl. No.: 14/522,839

(22) Filed: Oct. 24, 2014

(30) Foreign Application Priority Data
Oct. 24, 2013 (CN) 201310507486.3

(51) Int. Cl. G06T 7/00

(52) U.S. Cl. CPC G06T 7/0004; G06T 2207/10004; G06T 2207/30108
USPC 382/141

(57) ABSTRACT

A computing device debugs a computerized numerical control (CNC) machine. The computing device generates an average contour of a product. The computing device generates a reference contour according to the path points of a CNC program. The computing device calculates a coordinate difference between each path point of the reference contour and the corresponding contour point of the average contour. The computing device compensates each coordinate of the path points using the coordinate difference.

### CROSS-REFERENCE TO RELATED APPLICATIONS

This application claims priority to Chinese Patent Application No. 201310507486.3 filed on Oct. 24, 2013, the contents of which are incorporated by reference herein.

### FIELD

Embodiments of the present disclosure relate to debugging technology, and particularly to a computing device and a method for debugging a computerized numerical control machine.

### BACKGROUND

Computerized numerical control (CNC) machines can be used to process products (for example, a shell of a mobile phone), and measure a product to capture images of the product. However, for accurate processing, a CNC machine must be debugged.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device.

FIG. 2 shows a diagrammatic view of an example of an average contour.

FIG. 3 shows a diagrammatic view of an example of a coordinate difference each path point of the reference contour and the corresponding contour point of the average contour.

FIG. 4 is a flowchart of an example embodiment of a method for debugging a computerized numerical control (CNC) machine.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

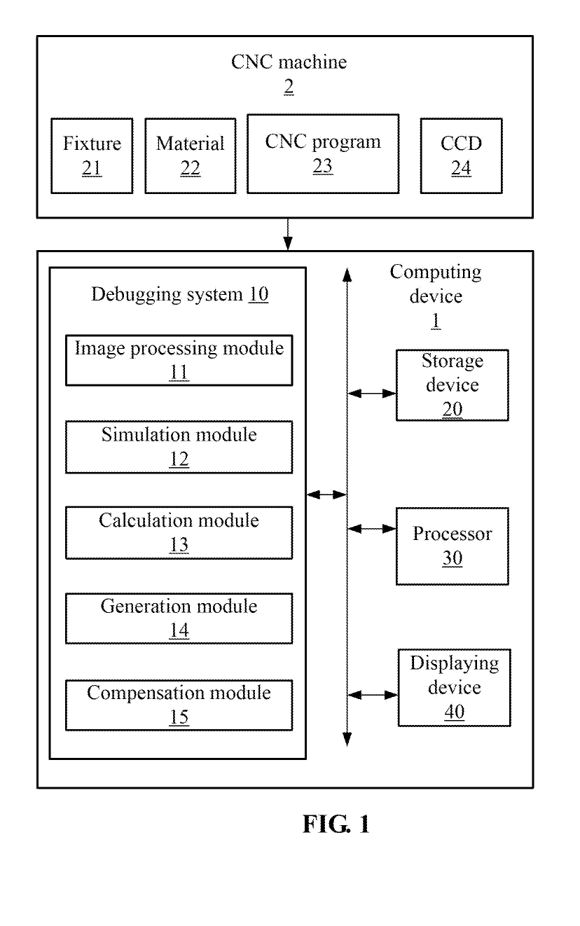

FIG. 1 illustrates a block diagram of an example embodiment of a computing device 1. In at least the embodiment, the computing device 1 provides functions of connections, so that a computerized numerical control (CNC) machine 2 can be connected to the computing device 1. In other embodiments, the computing device 1 can be integrated into the CNC machine 2. That is, the computing device 1 is a part of the CNC machine 2.

The computing device 1 can be, but is not limited to, a tablet computer, a server, a personal computer or any other computing device. In the example embodiment, the computing device 1 includes, but is not limited to, a debugging system 10, a storage device 20, at least one processor 30, and a displaying device 40. FIG. 1 illustrates only one example of the computing device 1, and other examples can comprise more or fewer components than those shown in the embodiment, or have a different configuration of the various components.

In at least one embodiment, the storage device 20 can be an internal storage device, such as a flash memory, a random access memory (RAM) for temporary storage of information, and/or a read-only memory (ROM) for permanent storage of information. The storage device 20 can also be an external storage device, such as an external hard disk, a storage card, or a data storage medium. The at least one processor 30 can be a central processing unit (CPU), a microprocessor, or other data processor chip that performs functions of the computing device 1.

The CNC machine 2 can capture images of products when the CNC machine 2 processes material 22 (for example, metal, or plastic) to the products. The CNC machine 2 includes a fixture 21, a CNC program 23 which is stored in a medium of the CNC machine 2, and a charge coupled device (CCD) 24. The CNC program 23 is an array program which consists of a plurality of coordinates of path points. The path points are a plurality of positions where the CNC machine 2 processes the material 22. In addition, the CNC program 23 can be, but is not limited to, stored in a TXT format file.

In at least embodiment, the material 22 is fixed on a platform of the CNC machine by the fixture 21. The CNC machine 2 performs the CNC program to process the material 22. For example, the CNC machine 2 cuts the material 22 using a blade of the CNC machine 2 when the CNC program 23 runs in the CNC machine 2. The material 22 can be processed into one or more products, for example, a shell of an electronic device (e.g., a mobile phone).

The CCD 24 is fixed onto a CNC principle axis of the CNC machine 2 by a fixture 21. To ensure an axis of an imaging plane of the CCD 24 is vertical to a processing plane of the CNC machine 2, a perpendicularity error needs to satisfy a predetermined precision requirement, for example, is less than 0.1 millimeter (mm). The imaging plane of the CCD 24 can be regarded as a plane which is parallel with the platform of the CNC machine 2. The processing plane of the CNC machine 2 can be regarded as another plane which is parallel with the platform of the CNC machine 2.

In at least one embodiment, the CNC machine 2 processes the material 22, so that a predetermined number (for example, five) of the products are processed. The CCD 24 captures images of each product which the material 22 is processed into the product. The images of each product are processed using a binary processing method, so that contour points of the product are obtained. The contour points of the product consist of a contour of the product in the image of the product. Furthermore, the contour points of each product are regarded as a point cloud. Each contour point of the product in the point cloud is related to a path point where the CNC machine 2 processes the material 22. In addition, due to each path point is related to one contour point of each point cloud, each path point is respectively related to a predetermined number of the contour points of point clouds. The predetermined number equals to the number of the point clouds.

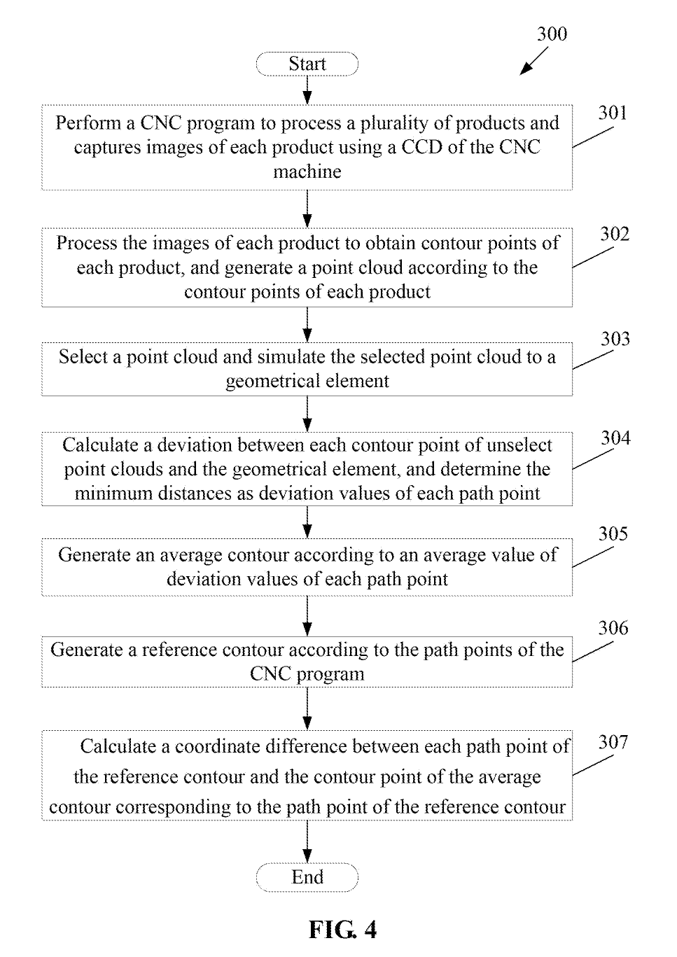

The debugging system 10 comprises, but is not limited to, an image processing module 11, a simulation module 12, a calculation module 13, a generation module 14, and a compensation module 15. Modules 11-15 can comprise computerized instructions in the form of one or more computer-readable programs that can be stored in a non-transitory computer-readable medium, for example the storage device 20, and executed by the at least one processor 30 of the computing device 1. A detailed description of the functions of the modules 11-15 is given below in reference to FIG. 4.

FIG. 4 illustrates a flowchart of an example embodiment of a method for debugging a CNC machine. In an example embodiment, the method is performed by execution of computer-readable software program codes or instructions by at least one processor of a computing device, and can automatically debug the CNC machine.

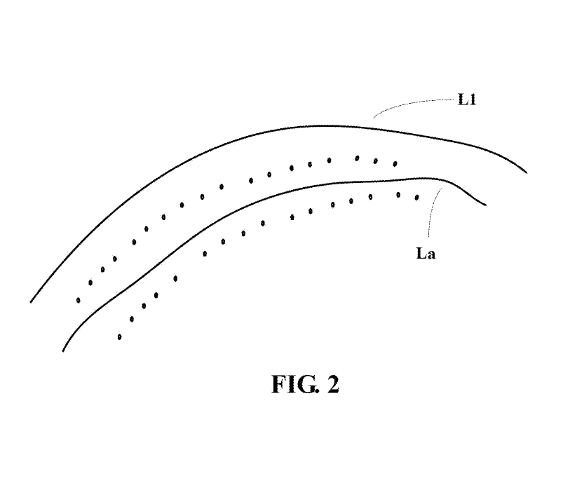

Referring to FIG. 4, a flowchart is presented in accordance with an example embodiment. The method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 4 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The example method 300 can begin at block 301.

In block 301, the CNC machine 2 processes the material 22 to produce a plurality of products according to the CNC program, and captures images of each product when the CNC 2 processes the material 22. In at least one embodiment, the CNC machine 2 moves a blade of the CNC machine 2 to each path point according to the CNC program 23. The CCD 24 captures one image of the product when the blade of the CNC machine 2 moves to one path point.

In block 302, the image processing module 11 processes the images of each product to obtain contour points of each product, and generates point clouds according to the contour points of each product. In at least one embodiment, the image processing module 11 processes the images of the product using a binary processing method to generate pixel gray values of each image. The image processing module 11 further obtain the contour points using the pixel gray values of each image. For example, if a pixel gray value of the image exceeds a predetermined pixel gray value (e.g., 155) which is at a range of [0, 255], the pixel gray value of the image is regarded as a contour point. In addition, the contour points of each product are regarded as a point cloud. That is, the image processing module 11 generates the point clouds. Each contour point of the product in the point cloud is related to a path point where the CNC machine 2 processes the material 22.

In block 303, the simulation module 12 selects one of the generated point clouds and simulate the selected point cloud into a geometrical element using a predetermined algorithm according to a predetermined type of the geometrical element. The predetermined type of the element can be, but is not limited to, a line type, a circle type or a surface type. The geometrical element can be, but is not limited to, a line, a circle or a surface. If the predetermined type of the element is the line type, the line is simulated. If the predetermined type of the element is the circle type, the circle is simulated. If the predetermined type of the element is the surface type, the surface is simulated. The predetermined algorithm can be, but is not limited to, a triangulation algorithm, a least square method, a singular value decomposition (SVD) method, or a quaternion algorithm. As shown in FIG. 2, the curve L1 is simulated according to one of N point clouds using the predetermined algorithm. The geometrical element stratifies the condition as following: an average of a sum of squares of distances between the points of the point clouds and the simulated geometrical element is minimum. The average of a sum of squares of distances can be calculated using a formula, such as, a quasi-Newton non-linear equation.

In block 304, the calculation module 13 calculates a minimum distance between each contour point of unselected point clouds and the geometrical element, and determines the minimum distance as a deviation value of each path point. In at least one embodiment, the minimum distance between each contour point of point clouds and the geometrical element is a deviation value of a path point corresponding to the contour point of the point clouds. For example, assuming that five point clouds are generated, which are a first point cloud, a second point, a third point cloud, a fourth point cloud and a fifth point cloud. If the first point clouds are simulated into the curve, the path point A is respectively related to a contour point A1 of the second point cloud, a contour point B1 of the third point cloud, a contour point C1 of the fourth point cloud, and a contour point D1 of the fifth point cloud, then the calculation module 13 calculates four minimum distances d1, d2, d3 and d4, which d1 indicates the minimum distance between the contour point A1 and the curve, d2 indicates the minimum distance between the contour point B1 and the curve, d3 indicates the minimum distance between the contour point C1 and the curve, d4 indicates the minimum distance between the contour point D1 and the curve. The four minimum distance d1, d2, d3 and d4 also are regarded as four deviation values of the path point A corresponding to the contour points A1, B1, C1 and D1.

In block 305, the generation module 14 calculates an average value of the deviation value of each path point, and generates an average contour according to the average value of the deviation values of each path point. The average contour is an adjusted curve according to the average value of the deviation values of each path point. The generation module 14 obtains contour points according to an average value of the deviation values of each path point. For example, as shown in FIG. 2, the average contour La is generated according to the obtained contour points.

In block 306, the generation module 14 further generates a reference contour according to the path points of the CNC program. In addition, the generation module 14 aligns the reference contour and the average contour.

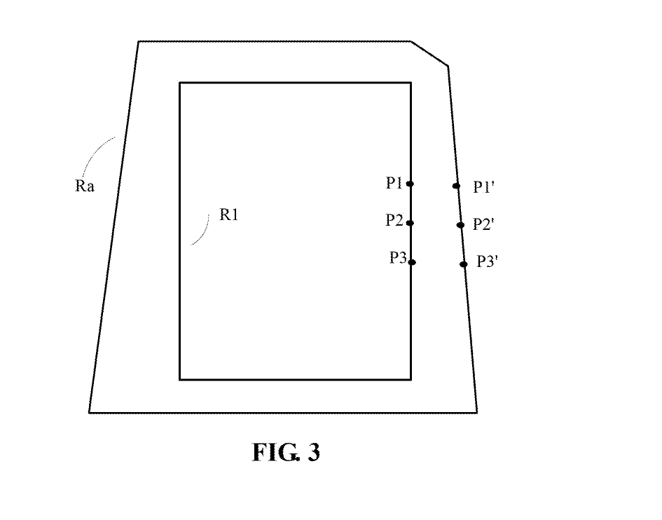

In block 307, the compensation module 15 calculates a coordinate difference between each path point of the reference contour and a contour point of the average contour corresponding to the path point of the reference contour. As shown in FIG. 3, Ra is the reference contour and R1 is the average contour. The path point P1 in the reference contour is related to the contour point P1′, the path point P2 in the reference contour is related to the contour point P2′, and the path point P2 in the reference contour is related to the contour point P2′, the coordinate difference between P1 and P1′ is calculated according to the coordinates of P1 and P1′, the coordinate difference between P2 and P2′ is calculated according to the coordinates of P2 and P2′, the coordinate difference between P3 and P3′ is calculated according to the coordinates of P3 and P3′. The coordinate compensation module 15 compensates coordinates of each path point using the coordinate difference. That is, the compensation module 15 adjusts the CNC program according to the coordinate difference, so that the CNC machine 2 accurately processes the material 22 using the adjusted CNC program.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device, comprising:
at least one processor; and
a storage device that stores one or more programs and a computerized numerical control (CNC) program including path points, wherein the one or more programs, when executed by the at least one processor, cause the at least one processor to:
process images of a plurality of products to obtain contour points of each product from the plurality of products;
generate a point cloud according to the contour points of each product from the plurality of products;
select one of the point clouds and simulate the point cloud selected into a geometrical element using a predetermined algorithm according to a predetermined type of the geometrical element;
calculate a minimum distance between each contour point of unselected point clouds and the geometrical element, and determine minimum distances as deviation values of each path point;
calculate an average value of the deviation values of each path point;
generate an average contour according to the average value of the deviation values of each path point;
generate a reference contour according to the path points;
calculate a coordinate difference between each path point of the reference contour and a contour point of the average contour corresponding to the path point of the reference contour; and
compensate coordinates of each path point using the coordinate difference.

2. The computing device of claim 1, wherein the contour points of each product are obtained by performing of:
processing the images of each product using a binary processing method to generate pixel gray values of each image; and
obtaining the contour points using the pixel gray value of each image.

3. The computing device of claim 2, wherein the pixel gray value of the image is determined as a contour point upon the condition that the pixel gray value of the image exceeds a predetermined pixel gray value.

4. The computing device of claim 1, wherein the predetermined type of the element is selected from a group consisting of a line type, a circle type and a surface type.

5. The computing device of claim 1, wherein the geometrical element is selected from a group consisting of a line, a circle and a surface.

6. The computing device of claim 1, wherein the predetermined algorithm is selected from a group consisting of a triangulation algorithm, a least square method, a singular value decomposition (SVD) method, and a quaternion algorithm.

7. The computing device of claim 1, wherein the CNC program is an array program which consists of a plurality of the coordinates of path points.

8. The computing device of claim 1, wherein the geometrical element stratifies the condition as following: an average of a sum of squares of distances between the points of the point clouds and the simulated geometrical element is minimum.

9. A computer-based method for debugging a computerized numerical control (CNC) machine using a computing device, the method comprising:
processing images of a plurality of products to obtain contour points of each product from the plurality of products, and generating a point cloud according to the contour points of each product from the plurality of products;
selecting one of the point clouds and simulating the point cloud selected into a geometrical element using a predetermined algorithm according to a predetermined type of the geometrical element;
calculating a minimum distance between each contour point of the unselected point clouds and the geometrical element, and determining the minimum distances as deviation values of each path point of a CNC program;
calculating an average value of the deviation values of each path point;
generating an average contour according to the average value of the deviation values of each path point;
generating a reference contour according to the path points;
calculating a coordinate difference between each path point of the reference contour and a contour point of the average contour corresponding to the path point of the reference contour; and
compensating coordinates of each path point using the coordinate difference.

10. The method of claim 9, wherein the contour points of each product are obtained by performing of:
processing the images of each product using a binary processing method to generate pixel gray values of each image; and
obtaining the contour points using the pixel gray value of each image.

11. The method of claim 10, wherein the pixel gray value of the image is determined as a contour point upon the condition that the pixel gray value of the image exceeds a predetermined pixel gray value.

12. The method of claim 9, wherein the predetermined type of the element is selected from a group consisting of a line type, a circle type and a surface type.

13. The method of claim 9, wherein the geometrical element is selected from a group consisting of a line, a circle and a surface.

14. The method of claim 9, wherein the predetermined algorithm is selected from a group consisting of a triangulation algorithm, a least square method, a singular value decomposition (SVD) method, or a quaternion algorithm.

15. The method of claim 9, wherein the CNC program is an array program which consists of a plurality of the coordinates of path points.

16. The method of claim 9, wherein the geometrical element stratifies the condition as following: an average of a sum of squares of distances between the points of the point clouds and the simulated geometrical element is minimum.
